(19) United States
(12) Patent Application Publication
(10) Pub. No.: US 2019/0281998 A1
(43) Pub. Date: Sep. 19, 2019

(54) CLIP DEVICE FOR DISPLAYING A TOWING PRODUCT

(71) Applicant: HORIZON GLOBAL AMERICAS INC., Plymouth, MI (US)

(72) Inventor: Eric Yukich, Stow, OH (US)

(21) Appl. No.: 16/352,236

(22) Filed: Mar. 13, 2019

Related U.S. Application Data
(60) Provisional application No. 62/642,724, filed on Mar. 14, 2018.

(51) Int. Cl. A47F 5/00; F16B 2/22; A47F 7/00

(52) U.S. Cl. CPC A47F 5/0006; A47F 7/00; F16B 2/22

(57) ABSTRACT

A merchandising clip for towing product is shown and described. The merchandising clip for towing products may comprise first and second elongated body members and a mounting body securely attached to the first and second elongated body members. Each of the elongated body members may comprise a base portion, an extending portion extending from the base portion, a support portion extending from the extending portion in which the support portion being offset from the first base portion, and an engaging portion extending from the support portion of which the engaging portion may be selectively attachable and securely engage with the ball mount product. The mounting body may selectively engage with a hook to maintain the towing product in a predetermined position. In one embodiment, the ball mount merchandising clip may further include a gripping surface or a surface coating. In another embodiment, the ball mount merchandising clip may further include a magnet member.

### CROSS REFERENCE TO RELATED APPLICATIONS

This application claims priority to and the benefit of U.S. Provisional Patent Application No. 62/642,724 filed on Mar. 14, 2018 titled, “BALL MOUNT MERCHANDISING CLIP” which is incorporated by reference in its entirety.

### TECHNICAL FIELD

The present invention is generally related to a merchandising clip for towing products and, more particularly, to a merchandising clip selectively attachable and securely engaging with a hitch assembly such as a ball mount assembly.

### BACKGROUND

In a typical retail store, it is common to find a product advertising or point of sale displays used for promotional purposes. Many towing products are heavy, large and have different configurations which require different brackets to properly display such merchandise. Moreover, the point of sale displays used for various towing products, for example hitch assemblies such as ball mount assemblies, are typically arranged in a spread and spaced configuration along a lower portion of the merchandising display rack of a retail store. One of the drawbacks with these types of display arrangements is that they typically require more space and lack full visibility in an attractive and coordinated manner with the desired promotional purposes. Further still, equipment used for such display arrangements are often intended to be used only temporarily and constructed of lightweight materials that may be easily damaged and are unable to be reused.

Therefore, provided is a merchandise holder assembly that addresses some of the issues in the market that utilizes economy of space while securely displays towing products in a merchandising display rack of a retail store. Furthermore, provided is a merchandising clip assembly configured to securely display towing products in a predetermined position that may be visible at the merchandising display rack or a display wall for users. The embodiments of the presently disclosed merchandising clip may be easily accessible and reusable.

### SUMMARY

Provided is a clip device for supporting a towing product on a merchandising display rack. The clip device comprises a mounting body. a first elongated body member and a second elongated body member, each of the first and second elongated body members extending from the mounting body. The first and second elongated body members each include a base portion, an extending portion extending from the base portion, a support portion extending from the extending portion, the support portion being offset from the base portion, and an engaging portion extending from the support portion, the engaging portion selectively engageable with an aperture of a towing product. The mounting body may be selectively engageable with a display hook on a merchandising display rack to maintain the towing product in a predetermined position. The engaging portion may include a gripping surface or a surface coating. A magnet member may be positioned on or in the engaging portion or in the mounting body. The engaging portions of each of the first and second elongated body members may include a receiving portion capable of engaging opposing apertures on the towing product. The first and second elongated body members may be symmetrical. The mounting body, said first elongated body member, and said second elongated body member may be monolithically formed. The first and second elongated body members may be generally spaced from one anther and be subject to a bias force acting thereon that maintains the first and second elongated body members in a generally open configuration. The first elongated body member may be configured to be biased towards the second elongated body member into an attachment position to be inserted within a cavity of the towing product. From the attachment position, the engaging portions of the first and second elongated body members may be configured to be biased outwardly to engage oppositely disposed apertures of the towing product.

In another embodiment, provided is a merchandising assembly for displaying a towing product comprising at least one towing product having a towing body that defines a cavity with opposing first and second apertures. A clip device comprising a mounting body, a first elongated body member and a second elongated body member, each of the first and second elongated body members extending from the mounting body. The first and second elongated body members each comprising a base portion, an extending portion extending from the base portion, a support portion extending from the extending portion, the support portion being offset from the base portion, and an engaging portion extending from the support portion, the engaging portion selectively engageable with an aperture of a towing product. The engaging portions of the first and second elongated body members may be selectively engageable with said first and second apertures of the towing product to maintain the towing product in a predetermined position. The cavity of the towing product incudes a generally hollow interior portion wherein portions of the first and second elongated members are insertable into the generally hollow interior portion such that the engaging portions are configured to be selectively engagable with the first and second apertures. The first and second elongated members may be symmetrical. The clip device may be monolithically formed. The first and second elongated body members may be generally spaced from one anther and are subject to a bias force acting thereon that maintains the first and second elongated body members in a generally open configuration. The first elongated body member may be configured to be biased towards the second elongated body member into an attachment position to be inserted within said cavity of the towing product. When in the attachment position, the engaging portions of the first and second elongated body members are configured to be biased outwardly to engage said opposing first and second apertures of the towing product.

In another embodiment, provided is a system for displaying a towing product on a merchandise display rack. The system includes a towing product, a display hook extending from a surface of a merchandising display rack, and a clip device insertable into and engageable with the towing product to hold and support the towing product on the display hook. The clip device comprising a mounting body, a first elongated body member, and a second elongated body member, each of the first and second elongated body members extending from the mounting body. The first and second elongated body members each comprising a base portion, an extending portion extending from the base portion, a support portion extending from the extending portion, the support portion being offset from the base portion, and an engaging portion extending from the support portion, the engaging portion selectively engageable with an aperture of a towing product. The mounting body may be selectively engageable with said display hook extending from said merchandising display rack to maintain the towing product in a predetermined position. The first and second elongated body members may be generally spaced from one anther and are subject to a bias force acting thereon that maintains the first and second elongated body members in a generally open configuration. The first elongated body member is configured to be biased towards the second elongated body member into an attachment position to be inserted within said cavity of the towing product. The engaging portions of the first and second elongated body members are configured to be biased outwardly to engage said opposing first and second apertures of the towing product.

### BRIEF DESCRIPTION OF THE DRAWINGS

Operation of the present teachings may be better understood by reference to the detailed description taken in connection with the following illustrations. These appended drawings form part of this specification, and written information in the drawings should be treated as part of this disclosure. In the drawings:

FIG. 1A is a perspective exploded view of an embodiment of a clip device separate from a towing product to be used with a typical merchandising display rack of a retail store;

FIG. 1B is a perspective view of an embodiment of a typical merchandising display rack of a retail store;

FIG. 2 is a perspective view of an embodiment of a clip device attached to a towing product an positioned on the display rack according to the instant disclosure;

FIG. 3 is a perspective view of an embodiment of the clip device in accordance with the instant disclosure;

FIG. 4A is a perspective view of an embodiment of the clip device in accordance with the instant disclosure;

FIG. 4B is a top view of the clip device of FIG. 4A;

FIG. 4C is a side view of the clip device of FIG. 4A;

FIG. 5A is a perspective view of another embodiment of the clip device in accordance with the instant disclosure;

FIG. 5B is a top view of the clip device of FIG. 5A;

FIG. 5C is a side view of the clip device of FIG. 5A; and

FIG. 6 is a perspective view of clip device separate from the towing product in accordance with the instant disclosure.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality, such those from other described embodiments herein. It is further noted that while various embodiments refer to a clip device, various other components may be utilized in view of embodiments described herein. Further, the present device and assembly may include a variety of components, not limited to the components discussed below such as towing products including a hitch ball or other type of hitch related assembly. Optionally, the present apparatus may include multiple units of the same components. In an embodiment, the present apparatus may include just the clip device described herein. Further, the present apparatus may include components of each of the clip device to create a combination of each feature of the various apparatus.

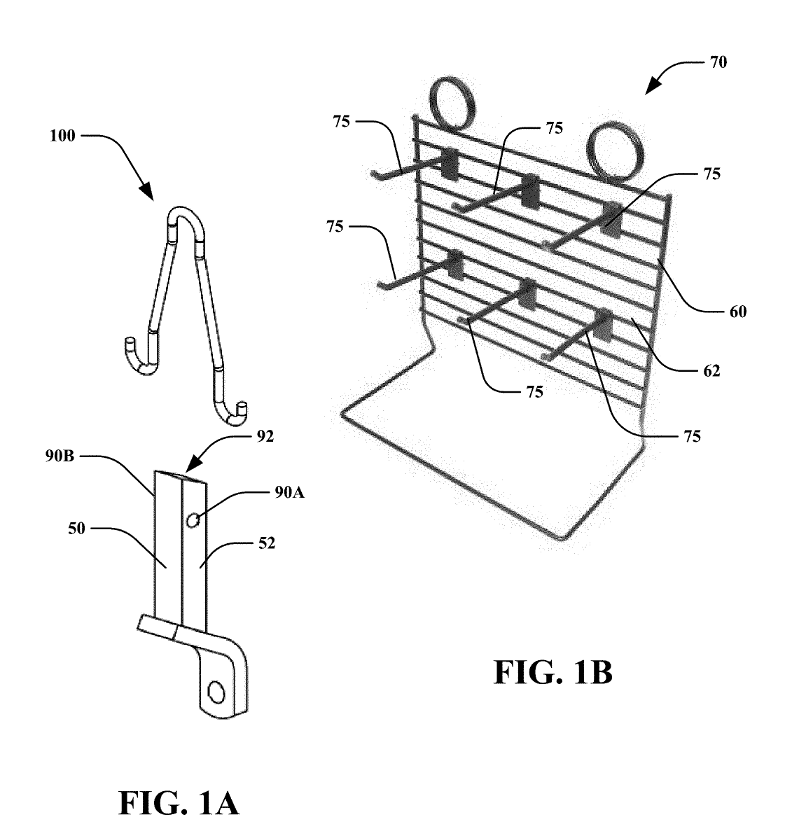

FIGS. 1A through 6 illustrate embodiments of a clip device 100 that may be positioned on a display rack 60 as shown and described herein. The clip device 100 may be constructed to selectively and removably store a towing product 50 that may be used in towing activities—such as a ball mount hitch assembly, an example of which is disclosed in U.S. Pat. No. 9,308,789, which is incorporated herein by reference. The clip device 100 may be used with any towing product 50. By way of a non-limiting example, the clip device 100 may be selectively attached to the towing product 50 that may be mounted and displayed on a merchandising display rack 60 which may be located in a retail store 70. The clip device 100 may be positioned on the display rack 60 when displaying towing products or any other products within the display rack 60. The configuration may allow for displaying a plurality of towing products within or on the display rack 60. The clip device 100 is advantageous for attaching to and supporting the weight of a towing product 60 that would otherwise be too heavy to be displayed with the display rack 60 without such device. In some embodiments, clip device 100 may be configured to selectively engage with a peg style hook or display hook 75 that extends from a surface 62 such as a wall or is directly onto the display rack 60, without having to reconfigure the clip device 100. FIG. 1B illustrates six peg-style hooks 75 that extend from the surface 62 of the display rack 60, but the present disclosure contemplates any number and arrangement of hooks 75 as well as other surfaces to display other products and the disclosure of such is not limited to what is shown.

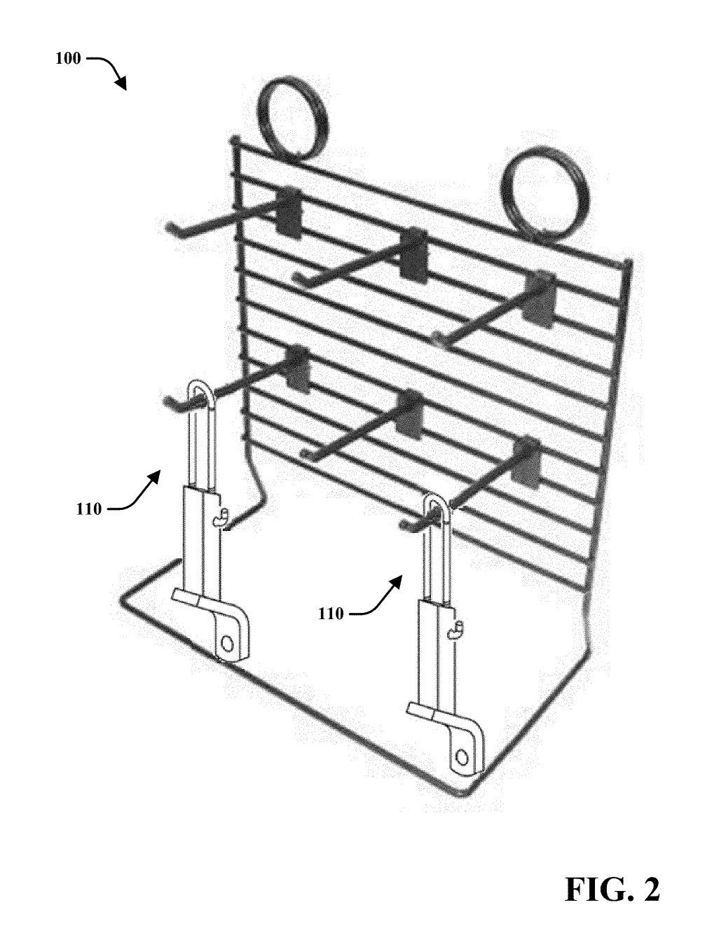

As shown in FIGS. 1A, 1B and 2, the clip device 100 may comprise any number of engaging members 110, including, without limitation the pair of engaging members 110. The pair of engaging members 110 may be substantially similar to one another; however, the present teachings contemplate any appropriate number of engaging members 110, including, without limitation, one, three, four, etc. In some embodiments, the pair of engaging member 110 may of a different configuration. The engaging member 110 may be structured to hold the towing product 50 in a storage position when the towing product 50 is operatively attached, as described in more detail below.

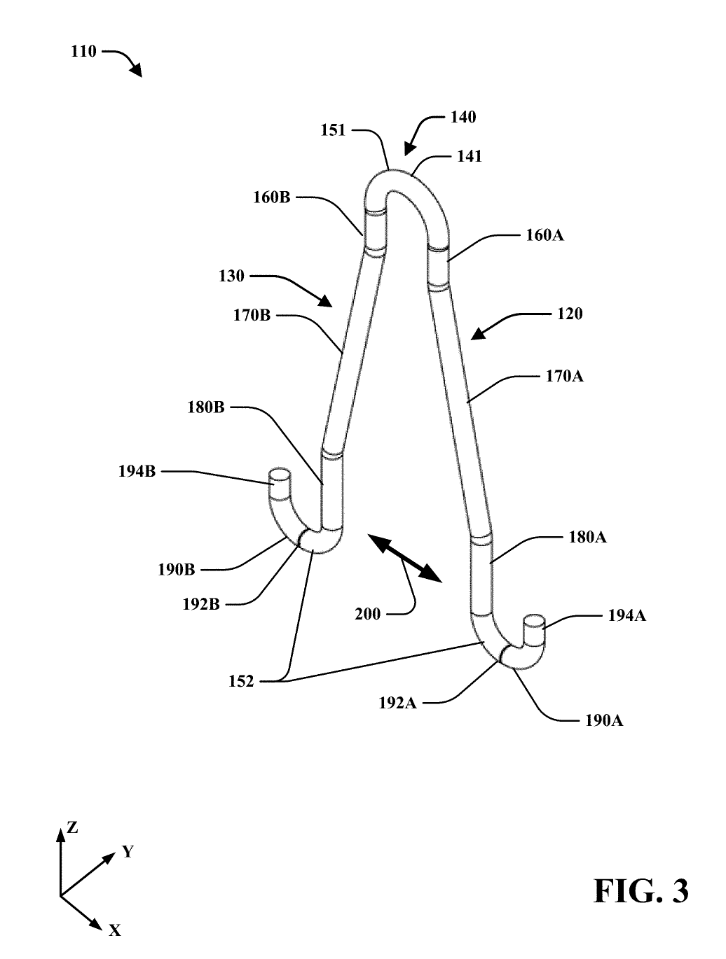

As illustrated in FIG. 3, the clip device 100 (or more particularly, each of the engaging members 110) may include first and second elongated body members 120, 130 and a mounting body 140. The first and second elongated body members 120, 130 may extend from the mounting body 140 along a z-axis as illustrated by FIG. 3. However, differently shaped portions of the engaging member 110 may be formed to accommodate towing products 50 of different sizes and/or configurations. The first elongated body member 120 may include a first base portion 160A, a first extending portion 170A, a first support portion 180A, and a first engaging portion 190A. The second elongated body member 130 may also include a second base portion 160B, a second extending portion 170B, a second support portion 180B, and a second engaging portion 190B. As will be described in detail below, the first and second elongated body members 120, 130 may be selectively engageable with the towing product 50 such that it may hold and support the towing mount product 50 in a storage position on a display rack 60.

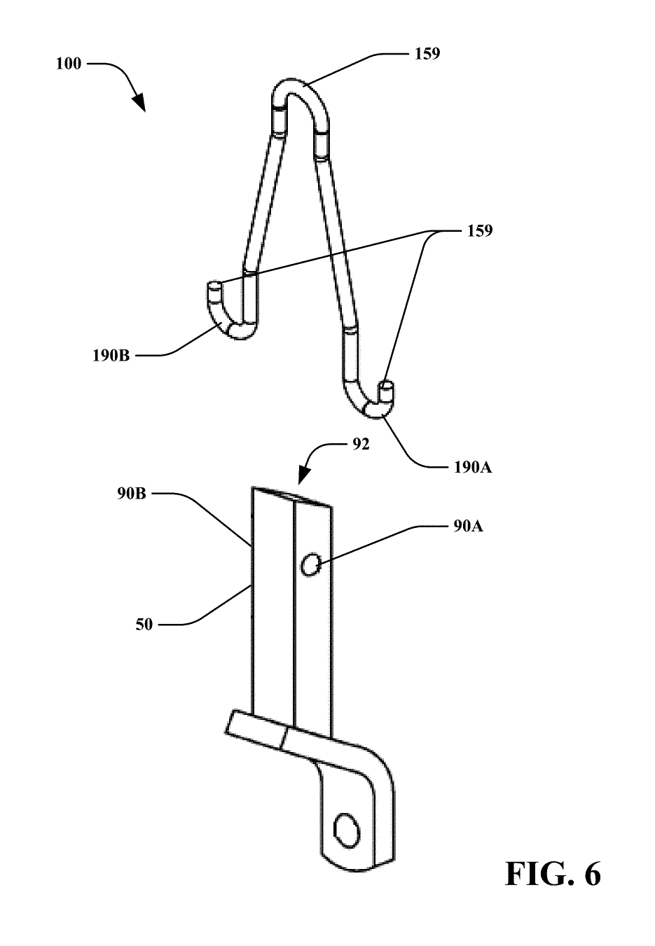

The mounting body 140 may be securely attached to the first and second elongated body members 120, 130 or may be monolithically formed therewith. The mounting body 140 may provide stability if and when the engaging member 110 is placed on or attached to a mounting stud, wall or a display peg-style hook 75, such as those shown selectively attached with the display rack 60 in FIGS. 1B and 2. The mounting body 140 may include a contoured shape 141, as shown in FIG. 3, so that the mounting body 140 maybe used as a hook when hanging the engaging member 110 to the mounting stud or the wall or more specifically to the peg-style hook 75. The mounting body 140 may be of any appropriate shape or size. The mounting body 140 may further include a magnet 159 coupled thereto (See FIG. 6), which may provide a holding force to help keep the clip device 100 operatively secured with the peg-style hook 75. For example, the magnet 159 may provide enough attraction force with the peg-style hook 75 (which may be formed of a metal to which the magnet 159 attracts) to keep the towing product 50 from being easily removed when on the display rack 60. The force, however, will not be sufficient enough for a user to overcome when removing the towing product 50 and clip device 100 from the peg-style hook 75.

The engaging member 110 may be constructed to securely support the weight of the ball mount product 50. The engaging member 110 may be made of any appropriate materials such as, steel, iron, chrome, aluminum, sheet metal or other alloy, or polymer, plastic or the like to generally provide structural stability to the engaging member 110. The engaging member 110 in may include a generally cylindrical shape with a width and a length. However, the engaging member 110 may include different configurations than the generally cylindrical shape, which is merely exemplary. The engaging member 110 may be formed as a monolithic unit or may be attached through a subsequent operation such as welding, fastening or adhering. By way of a non-limiting example, the engaging member 110 may be formed by stamping or extruding, which may create a generally smooth, reinforced structure.

The engaging member 110 of the clip device 100 may include a top side 151 and an opposite bottom side 152 along the z-axis. The first and second base portions 160A, 160B may extend downwardly from the mounting body 140 and be aligned along the z-axis. The first extending portion 170A of the first elongated body member 120 may angle outwardly along x-axis relative to the first base portion 160A and extend diagonally from the bottom side 152 of the clip device 100. The first extending portion 170A may include the angle such that the first support portion 180A may be offset from the first base portion 160A along the z-axis. This configuration may result in a generally S-shape. In one embodiment, the first extending portion 170A may be arcuate. Alternatively, the first extending portion 170A may be straight. The first support portion 180A may extend along the z-axis from the first extending portion 170A.

The first engaging portion 190A may extend along the x-axis from the first support portion 180A opposite from the first extending portion 170A. The first engaging portion 190A may include a receiving portion 192A having a generally curved engagement shape for securely holding and supporting the towing product 50 in a predetermined position, i.e., a storage position. The first engaging portion 190A may be of any appropriate shape or size, such as having a generally curvilinear or other profiled shape and length. By way of a non-limiting example, the first engaging portion 190A may be formed by stamping or extruding, which may create a generally smooth, reinforced structure. In some embodiments, the first engaging portion 190A may be arcuate. The first engaging portion 190A may further include a first receiving portion 194A which may provide a smooth engagement when the towing products 50 are engaged with the clip device 100. The first receiving portion 194A may be a hook configured to be aligned in a co-terminus position with an first aperture 90 in the towing product 50 when the clip device 100 is operatively positioned in the towing product 50. The first receiving portion 194A may be angled such that it may be configured to slide within the first aperture 90A of the towing product 50 from within a cavity 92 of the towing product 50 such that a frame portion 52 of the towing product 50 may rest along the first receiving portion 192A of the first engaging portion 190A.

The first and second elongated body members 120, 130 of the engaging member 110 may be symmetrically or generally symmetrically (i.e., minor tolerance differences, slight differences in configuration or shape) formed along z-axis. The first and second base portions 160A, 160B may extend downwardly from the mounting body 140 and be aligned along the z-axis. Similar to the first elongated body members 120, the second extending portion 170B of the second elongated body member 130 may bent outwardly along x-axis relative to the second base portion 160B with an angle and extend diagonally from the bottom side 152 of the clip device 100. The second extending portion 170B may include the angle such that the second support portion 180B may be offset from the second base portion 160B along the z-axis. This configuration may result in a generally S-shape. In one embodiment, the second extending portion 170B may be arcuate. Alternatively, the second extending portion 170B may be straight. The second support portion 180B may extend along the z-axis from the second extending portion 170B.

The second engaging portion 190B may extend along the x-axis from the second support portion 180B. The second engaging portion 190B may include a second receiving portion 192B having a generally curved engagement shape for securely holding and supporting the towing product 50 in a predetermined position, i.e., a storage position. The second engaging portion 190B may be of any appropriate shape or size, such as having a generally curvilinear or other profiled shape and length. By way of a non-limiting example, the second engaging portion 190B may be formed by stamping or extruding, which may create a generally smooth, reinforced structure. In some embodiments, the second engaging portion 190B may be arcuate. The second engaging portion 190B may further include a second receiving portion 194B which may provide a smooth engagement when the towing products 50 are engaged with the clip device 100. The second receiving portion 194B may be a hook configured to be aligned in co-terminus relationship with a second aperture 90B in the towing product 50 when the clip device 100 is operatively positioned in a cavity 92 of the towing product 50. The second receiving portion 194B may be angled such that it may be configured to slide within the second aperture 90B aligned opposite from the first aperture 90A within the cavity 92 of the towing product 50 from within the cavity 92 of the towing product 50 such that a frame portion 52 of the towing product 50 may rest along the second receiving portion 192B of the second engaging portion 190B.

The first and second elongated body members 120, 130 of the engaging member 110 may be subject to a bias force 200 acting thereon that maintains the engaging member 110 in a generally open configuration as illustrated by FIG. 2. In use, a user may apply an opposing bias force to the clip device 100, or more specifically, the engaging member 110, to bias the first elongated body member 120 towards the second elongated body member 130 into an attachment position to be inserted within the cavity 92 of the towing product 50. This configuration may allow placement of the first and second engaging portions 190A, 190B within the cavity 92 such that portions of engaging portions 190A, 190B may abut against an inner wall of the cavity 92 of the towing product 50 or may place the first and second engaging portions 190A, 190B out of the first and second apertures 90A, 90B of the towing product 50 as described in more detail below.

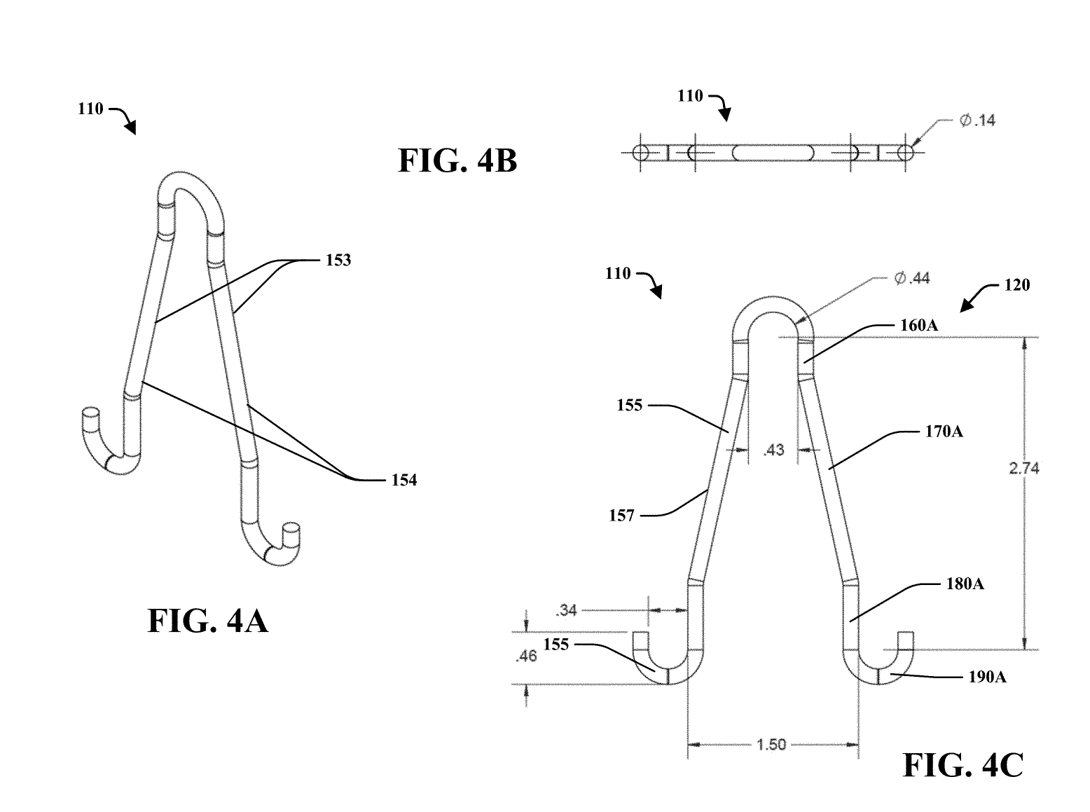

FIGS. 4A-4C illustrate an exemplary embodiment of the clip device 100. In this particular embodiment, the vertical length from a top of the first base portion 160A to a bottom of the first support portion 180A of the first elongated body member 120 may be approximately 2.74 inches. A horizontal distance between outer surfaces of the first and second support portions 180A, 180B of the elongated body members 120, 130 may be about 1.5 inches. A horizontal distance between outer surfaces of the first and second base portions 160A, 160B of the elongated body members 120, 130 may be about 0.43 inches. In such embodiment, the first engaging portion 190 may be generally cylindrically shaped and include a diameter measurement of about 0.14 inches in diameter. The present disclosure, however, is not limited to any particular length or shape of the first and second elongated body members 120, 130. These dimensions are merely exemplary and not limiting. Further, the vertical length from a top of the first base portion 160A to a bottom of the first support portion 180A of the elongated body members 120 may be between 2.5 and 2.9 inches in length and a horizontal distance between outer surfaces of the first and second elongated body members 120A, 130A may be between 1 and 2 inches in length. In such embodiment, the first engaging portion 190A may be 0.1 to 0.5 (or more) inches in diameter. Additionally, such measurement may be contemplated for the second engagement portion 190B.

With respect to FIG. 4A, the first and second elongated body members 120, 130 may further have a grip 153. The grip 153 may be a sleeve member that is placed on or otherwise surrounds the first and second elongated body members 120, 130. The grip 153 may be a knurled pattern disposed on the first and second elongated body members 120, 130. Alternatively, the grip 153 may be of any configuration that assists the user to grasp the first and second elongated body members 120, 130. By way of a non-limiting example, the grip 153 may include bumps, grooves, slots, raised surfaces or depressed surfaces that assist the user in gripping the first and second elongated body members 120, 130. Further, the grip 153 may be of any appropriate shape or size, such as having a generally tubular, square, rectangular, or the like shape. The grip 153 may be manufactured of any appropriate material such as an elastomeric material or a combination of elastomeric material and metal or a hard rubber or plastic.

By way of a non-limiting example, the grip 153 may also be a solid shell with a texture and/or a color. The grip 153 may be made of a weather, ultra violet (UV) and/or shatter resistant polymer such as ABS and polycarbonate. The grip 153 may have a gripping surface 154 thereon having an ornamental shape made with precision molding contours thereon. These shapes may help the user grip the driving sleeve. The gripping surface 154 may be made by over-molding including insert molding, double shot molding, co-injection molding as well as hot stamping for a decorative finish and sonic welding for attachment of various features. However, the grip 153 may be made of any appropriate materials and colors and this disclosure is not limited in this regard.

Referring to FIG. 4C, the first and second elongated body members 120, 130 may further include a product protector 155. The product protector 155 may be a sleeve securely fixed to the first and second elongated body members 120, 130. The product protector 155 may provide protection to the towing products 50 from getting scratched when being operatively positioned on the ball mount merchandising clip 100. The product protector 155 may be of any appropriate shape or size, such as having a generally tubular, square, rectangular, or the like shape, and may be sized. The product protector 155 may be manufactured of any appropriate material such as metal and/or elastomeric material. The product protector 155 may also increase the friction between the towing products 50 and the ball mount merchandising clip 100 when attached. This further may prevent unwanted movement of the towing products 50.

The first and second elongated body members 120, 130 may further include a surface coating 157. The surface coating 157 may be securely attached to the first and second elongated body members 120, 130. By way of a non-limiting example, the surface coating 157 may be a solid shell with a texture and/or a color. The surface coating 157 may be made of a weather, ultra violet (UV) and/or shatter resistant polymer such as ABS and polycarbonate and/or with IP-67 rating.

The engaging member 110 may further include a strap member (not shown) that may be used to selectively engage the towing products 50 with the loading surface, such as the first elongated body member 120. By way of a non-limiting example, a safety chain, rope, bungee cord, strap or the like may selectively engage the towing products 50. This may generally prevent the towing products 50 from being inadvertently moved from the clip device 100.

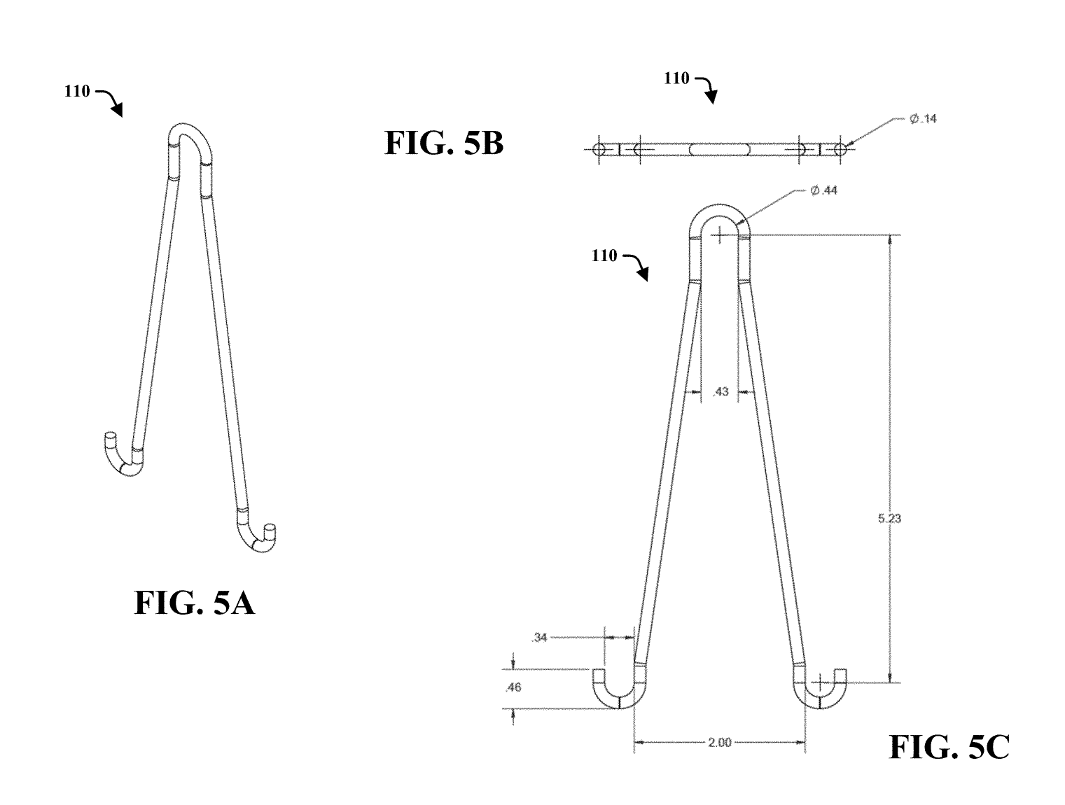

FIGS. 5A-5C illustrate another exemplary embodiment of the clip device 100. This embodiment, the vertical length from a top of the first base portion 160A to a bottom of the first support portion 180A of the elongated body members 120 may be 5.23 inches in length (or may be between 5 and 5.5 inches in length) and a horizontal distance between outer surfaces of the first and second elongated body members 120, 130 may be 2.0 inches in length (or may be between 1.5 and 2.5 inches in length). In such embodiment, the first engaging portion 190A may be 0.14 inches in diameter (or between 0.1 and 0.5 inches in diameter). The present disclosure, however, is not limited to any particular length of the first and second elongated body members 120, 130.

In operation shown in FIG. 6, the first and second first engaging portions 190A, 190B may be selectively engaged with and disengaged from first and second apertures 90A, 90B. Typically, the towing product includes a pair of apertures on opposing sides for use in receiving a pin to be assembled with a towing vehicle. The first and second first engaging portion 190A, 190B may further include a magnet 159 coupled thereto. The magnet 159 may allow the first and second first engaging portion 190A, 190B to be releasably secured to an appropriate surface via magnetic force while the engaging member 110 selectively and securely engage the towing products 50. The magnet 159 may be secured to the engaging member 110 in various suitable manners. In some embodiments, magnet 159 may be sized such that it may be securely and releasably snapped-in to the apertures 90 of the towing products 50 to which it is attached. In the alternative, the magnet 159 may not be used and friction force or gravity force instead utilized.

The first and second engaging portions 190A, 190B may have an outer diameter and shape that is generally complimentary to the diameter and shape of the first and second apertures 90A, 90B. The outer diameter of the first and second engaging portions 190A, 190B may be of a shape and size that it is configured to be insertable within and through the apertures. The fit between the first and second first engaging portions 190A, 190B and the apertures 90A, 90B may be snuggly inserted such that the aperture is just large enough to allow the first and second engaging portions 190A, 190B to pass therethrough, e.g., the first and second engaging portions 190A, 190B may be shaped as a button that substantially fills the aperture 90 when the clip device 100 is operatively inserted into the towing product 50. In some embodiments, for example as shown in FIGS. 4A-5C, the outer diameter of the first and second elongated body members 120, 130 may be 0.14 inches in diameter. The present disclosure, however, is not limited to any particular diameter of the first and second elongated body member 120, 130.

While a single engaging member 110 is described above, the a plurality of engaging members 110 may be structured generally in the same manner as the opposing side may have generally identical structure, i.e., the two sides may be generally symmetrically identical.

Although the embodiments have been illustrated in the accompanying drawings and described in the foregoing detailed description, it is to be understood that the present teachings are not to be limited to just the embodiments disclosed, but that the teachings described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A clip device for supporting a towing product on a merchandising display rack comprising:
a mounting body; and
a first elongated body member and a second elongated body member, each of the first and second elongated body members extending from the mounting body and comprising:
a base portion;
an extending portion extending from the base portion;
a support portion extending from the extending portion, the support portion being offset from the base portion; and
an engaging portion extending from the support portion, the engaging portion selectively engageable with an aperture of a towing product; and
wherein the mounting body selectively engageable with a display hook on a merchandising display rack to maintain the towing product in a predetermined position.

2. The clip device of claim 1, wherein the engaging portion further includes a gripping surface.

3. The clip device of claim 1, wherein the engaging portion further includes a surface coating.

4. The clip device of claim 1 further comprising a magnet member positioned on or in the engaging portion.

5. The clip device of claim 1 further comprising a magnet positioned on or in the mounting body.

6. The clip device of claim 1, wherein the engaging portions of each of the first and second elongated body members include a receiving portion capable of engaging opposing apertures on the towing product.

7. The clip device of claim 1, wherein the first and second elongated body members are symmetrical.

8. The clip device of claim 1, wherein the said mounting body, said first elongated body member, and said second elongated body member monolithically formed.

9. The clip device of claim 1, wherein the first and second elongated body members are generally spaced from one anther and are subject to a bias force acting thereon that maintains the first and second elongated body members in a generally open configuration.

10. The clip device of claim 9, wherein the first elongated body member is configured to be biased towards the second elongated body member into an attachment position to be inserted within a cavity of the towing product.

11. The clip device of claim 10, wherein the engaging portions of the first and second elongated body members are configured to be biased outwardly to engage oppositely disposed apertures of the towing product.

12. A merchandising assembly for displaying a towing product comprising:
at least one towing product having a towing body that defines a cavity with opposing first and second apertures; and
a clip device comprising:
a mounting body; and
a first elongated body member and a second elongated body member, each of the first and second elongated body members extending from the mounting body and comprising:
a base portion;
an extending portion extending from the base portion;
a support portion extending from the extending portion, the support portion being offset from the base portion; and
an engaging portion extending from the support portion, the engaging portion selectively engageable with an aperture of a towing product; and
wherein the engaging portions of the first and second elongated body members are selectively engageable with said first and second apertures of the towing product to maintain the towing product in a predetermined position.

13. The assembly of claim 12, wherein the cavity of the towing product incudes a generally hollow interior portion wherein portions of the first and second elongated members are insertable into the generally hollow interior portion such that the engaging portions are configured to be selectively engagable with the first and second apertures.

14. The assembly of claim 12, wherein the first and second elongated members are symmetrical.

15. The assembly of claim 12, wherein the clip device is monolithically formed.

16. The assembly of claim 12, wherein the first and second elongated body members are generally spaced from one anther and are subject to a bias force acting thereon that maintains the first and second elongated body members in a generally open configuration.

17. The assembly of claim 16, wherein the first elongated body member is configured to be biased towards the second elongated body member into an attachment position to be inserted within said cavity of the towing product.

18. The assembly of claim 17, wherein the engaging portions of the first and second elongated body members are configured to be biased outwardly to engage said opposing first and second apertures of the towing product.

19. A system comprising:
a towing product;
a display hook extending from a surface of a merchandising display rack; and
a clip device insertable into and engageable with the towing product to hold and support the towing product on the display hook, the clip device comprising:
a mounting body; and
a first elongated body member and a second elongated body member, each of the first and second elongated body members extending from the mounting body and comprising:
a base portion;
an extending portion extending from the base portion;
a support portion extending from the extending portion, the support portion being offset from the base portion; and
an engaging portion extending from the support portion, the engaging portion selectively engageable with an aperture of a towing product; and
wherein the mounting body is selectively engageable with said display hook extending from said merchandising display rack to maintain the towing product in a predetermined position.

20. The system of claim 19, wherein the first and second elongated body members are generally spaced from one anther and are subject to a bias force acting thereon that maintains the first and second elongated body members in a generally open configuration;
wherein the first elongated body member is configured to be biased towards the second elongated body member into an attachment position to be inserted within said cavity of the towing product; and
wherein the engaging portions of the first and second elongated body members are configured to be biased outwardly to engage said opposing first and second apertures of the towing product.
